(19) United States
(12) Patent Application Publication
(10) Pub. No.: US 2009/0296761 A1
(43) Pub. Date: Dec. 3, 2009

(54) Optical device including a bimorph-type piezoelectric element

(75) Inventor: Katsuhiko Hakomori, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/320,524

(22) Filed: Jan. 28, 2009

(30) Foreign Application Priority Data
May 28, 2008 (JP) 2008-138846

(51) Int. Cl. H01S 3/04

(52) U.S. Cl. 372/34

(57) ABSTRACT

An optical device includes optical parts including a laser diode element accommodated in a housing. A bimorph-type piezoelectric element is arranged in a vicinity of the laser diode element and has a free end contacting one of the laser diode element, a support member supporting the laser diode element, and the housing. A control circuit controls an operation of the bimorph-type piezoelectric element.

### CROSS-REFERENCE TO RELATED APPLICATIONS

This application is based upon and claims the benefit of priority of the prior Japanese Patent Application No. 2008-138846, filed on May 28, 2008, the entire contents of which are incorporated herein by reference.

### FIELD

The embodiments discussed herein are directed to an optical device.

### BACKGROUND

In optical transmission systems, such as a synchronous optical transmission network or a synchronous digital hierarchy system, a synchronized single optical signal of a single wavelength is transmitted using a single optical fiber. In an optical intermediate relay station and an optical terminal station used in such a system, an optical module incorporating a laser diode (LD) element for emission of light and a photodiode (PD) element for reception of light is used.

Generally, an LD element used for a direct modulation type transmitting optical module is not used as a single chip. For example, an LD element is used in a state where the LD element is incorporated into an optical device having a structure combinable with an optical fiber. As such an optical device, there are a light-emitting device referred to as TOSA (Transmitter optical Sub Assembly) and a light-receiving device referred to as ROSA (Receiver Optical Sub Assembly). Generally, the TOSA includes a laser diode (LD) element and an optical combining part for connecting the LD element to an optical fiber. On the other hand, generally, the ROSA includes a photodiode (PD) element and an LSI for processing signals converted by the PD element.

FIG. 1 is an exploded perspective view of an optical device formed by incorporating the above-mentioned TOSA and ROSA into a single case. FIG. 2 is a front view of the optical device illustrated in FIG. 1. An optical connector part la connected to an LD element included in a TOSA and an optical connector part 2a connected to a PD element 2 included in a ROSA are inserted into a groove part of a holder 4 provided in a case 3 of the optical device. When a lid 5 is attached to the case 3, the LD element 1 and the PD element 2 are fixed by being sandwiched between the lid 5 and a heat transfer sheet 6 applied to a bottom surface of the case 3.

A circuit board 7 on which electronic parts are mounted is also accommodated in the case 3. The electronic parts mounted on the circuit board 7 include an LSI forming an LD drive circuit for driving the LD element 1 and an LSI forming a PD operating circuit for operating the PD element 2.

The LD element 1, the PD element 2 and LSIs accommodated in the case 3 are heat-generating parts, and heat from those elements and LSIs is emitted to an atmosphere through the metal case 3. Because the LD element 1 and the PD element 2 are pressed onto a heat transfer sheet 6 attached to the inner surface of the case 3, the heat generated inside the LD element 1 and the PD element 2 is mainly transmitted to the case 3 through the heat transfer sheet 6, and is emitted to the atmosphere from the case 3. That is, the heat transfer sheet 6 and the case 3 function as a heat sink (cooling means) of the LD element 1 and the PD element 2.

Although an LSI for an LD drive circuit and an LSI for a PD operation circuit, which are mounted on the circuit board 7, also generate heat, the heat from those LSIs is transmitted to the case 3 through the circuit board 7, and is transmitted to the case 3 through the air inside the case 3, and, finally emitted to the atmosphere from the case 3.

As mentioned above, the LD element 1 radiates heat through the heat transfer sheet 6 and the case 3, and a thermal resistance between the LD element 1 and the atmosphere of the case 3 is constant. That is, the amount of heat radiated from the LD element 1 is proportional to a temperature difference between the LD element 1 and the atmosphere of the case 3, and becomes a constant value.

Here, although a normal temperature range of an environment where an optical device is installed is, for example, 0 to 60° C., a temperature range of, for example, −40° C. to +85° C. is required for one specified as a wide temperature range. That is, it is required for an LD element to normally operate and emit a light in the environmental temperature range of −40° C. to +85° C.

However, the main luminescence wavelength in an emission spectrum of an LD element greatly changes according to a temperature of the LD element. Because mass-produced LD elements have variation in a normal operation temperature range where it is operable appropriately, in the present circumstances, LD elements that meet a use environment are selected and used. That is, mass-produced LD elements are driven, and ones that can normally operate in the temperature range of −40° C. to +85° C. are selected. Thus, a yield rate of the LD element is low, which results in an increase in the cost of the LD element. The LD element itself has a problem in that a threshold value current (bias current) particularly at a low temperature is small and it is difficult to control an operating current at a low temperature.

A fluctuation in a luminescence wavelength can be suppressed and variation of a normal operation temperature range can be absorbed by measuring a temperature of an LD element and performing a temperature control so that the temperature in operation is within a fixed range. In order to perform such a temperature control, it is necessary to measure the temperature of the LD element with sufficient accuracy. However, when measuring the temperature of the LD element using a thermister, there is a temperature difference between the LD element and a position where the thermister is mounted, which results in a problem in that the temperature detected by the thermister does not match an actual temperature of the LD element.

In order to solve such a problem, it is suggested to provide a thermal resistance reducing means such as a metal wire between an extreme vicinity of the LD element and the thermister so as to minimize a temperature difference between the LD element and the thermister as much as possible to reduce a temperature measurement error (for example, refer to Patent Document 1). Additionally, it is suggested to reduce a temperature measurement error of a semiconductor module by supporting the semiconductor module incorporating an LD element by first and second support units and providing a temperature sensor and a heat blocking means on the second support unit and the semiconductor module (for example, refer to Patent Document 2).

Patent Document 1: Japanese Laid-Open Patent Application No. 2004-79989

Patent Document 2: Japanese Laid-Open Patent Application No. 2003-31884

According to a method of measuring an actual temperature of an LD element in an optical device to stabilize the characteristics of the LD element, a temperature measuring means and a temperature control means must be provided in the optical device, thereby greatly increasing a manufacturing cost of the optical device, which is not practical.

Thus, it is desirous to control a temperature of a laser diode (LD) in an optical device without measuring a temperature by a temperature sensor.

### SUMMARY

There is provided an optical device including: optical parts including a laser diode element; a housing accommodating the optical parts; a bimorph-type piezoelectric element arranged in a vicinity of the laser diode element and having a free end contacting one of the laser diode element, a support member supporting the laser diode element, and the housing; and a control circuit controlling an operation of the bimorph-type piezoelectric element.

The object and advantages of the embodiment will be realized and attained by means of the elements and combinations particularly pointed out in the appended claims.

It is to be understood that both the foregoing general description and the following detailed description are exemplary explanatory only and are not restrictive of the invention, as claimed.

### BRIEF DESCRIPTION OF DRAWINGS

FIG. 1 is an exploded perspective view of an optical device formed by incorporating TOSA and ROSA into a single case;

FIG. 2 is a front view of the optical device illustrated in FIG. 1;

FIGS. 3A and 3B are illustrations for explaining an operation of a temperature control mechanism of an LD element;

FIG. 4 is an illustration for explaining an effect of the temperature control mechanism illustrated in FIG. 3;

FIG. 5 is an exploded perspective view of an optical device according to a first embodiment;

FIG. 6 is a plan view of the optical device illustrated in FIG. 5 in a state where a lid is removed;

FIG. 7 is a side view illustrating a periphery of an LD element incorporated in a case;

FIGS. 8A and 8B are simplified views illustrating a positional relationship between the LD element and a piezoelectric element when viewing from a front direction of the optical device illustrated in FIG. 5;

FIG. 9 is a view illustrating the piezoelectric element illustrated in FIG. 6 and a periphery of the piezoelectric element

FIG. 10 is a plan view illustrating an LD element and a piezoelectric element in an optical device according to a second embodiment;

FIG. 11 is a side view illustrating the LD element and the piezoelectric element illustrated in FIG. 10;

FIGS. 12A and 12B are illustrations for explaining an operation of the piezoelectric element illustrated in FIG. 10;

FIG. 13 is a plan view illustrating an LD element and a piezoelectric element in an optical device according to a third embodiment;

FIG. 14 is a side view illustrating the LD element and the piezoelectric element illustrated in FIG. 13;

FIGS. 15A and 15B are illustrations for explaining an operation of the piezoelectric element illustrated in FIG. 13; and

FIG. 16 is a graph indicating a temperature rise of an LD element after a power is turned on.

### DESCRIPTION OF EMBODIMENT(S)

Preferred embodiment of the present invention will be explained with reference to the accompanying drawings.

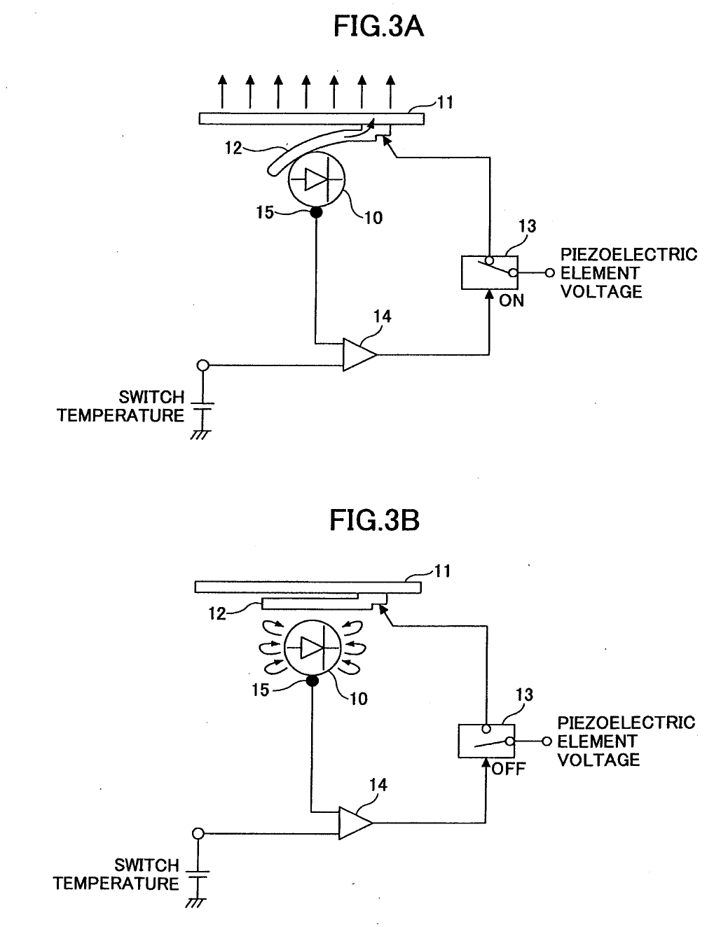

First, a description will be given of a temperature control mechanism of an LD element. FIGS. 3A and 3B are illustrations for explaining an operation of a temperature control mechanism of an LD element. In the temperature control mechanism illustrated in FIGS. 3A and 3B, a temperature of the LD element is caused to be raised by self-heating of the LD element, especially when the LD element is operated at a low-temperature. Thereby, even if an ambient temperature is very low, the temperature of the LD element can-be raised to a temperature at which the LD element can be operated normally. Therefore, even if the normal operation temperature of the LD element is high especially on the low-temperature side, the LD element can be operated normally by raising the temperature of the LD element only when the temperature is low.

As illustrated in FIGS. 3A and 3B, the LD element 10 shall be arranged near an inner wall of a case 11, which also functions as a heat-radiating part. A bimorph-type piezoelectric element 12 is attached to the inner wall of the case 11. The bimorph-type piezoelectric element 12 has a characteristic such that it deforms (bends) in one direction when a voltage is applied (hereinafter, the bimorph-type piezoelectric element 12 may be simply referred to as piezoelectric element 12). One end of the piezoelectric element 12 is attached to the case 11, and an opposite end is free. When a voltage is applied to the piezoelectric element 12, the piezoelectric element 12 deforms, and the free end of the piezoelectric element 12 contacts the LD element 10 as illustrated in FIG. 3A. On the other hand, when a voltage is not applied to the piezoelectric element 12, the piezoelectric element 12 returns to its original shape, and the free end of the piezoelectric element 12 separates from the LD element 10 as illustrated in FIG. 3B.

An application and stop of the drive voltage to the piezoelectric element 12 is switched by a switch 13. The operation of the switch 13 is controlled by a signal from a comparison circuit 14. The comparison circuit 14 compares a temperature of the piezoelectric element 12 detected by a temperature sensor 15 with a previously set switch temperature, and supplies an ON signal to the switch 13 in accordance with the result of comparison. That is, when the temperature of the LD element 10 is equal to or higher than the switch temperature, the comparison circuit 14 outputs the ON signal, which causes the switch 13 to turn on. Thereby, the switch 13 is changed to a side which applies the drive voltage to the piezoelectric element 12 (FIG. 3A). On the other hand, when the temperature of a piezoelectric element 12 is lower than the switch temperature, the comparison circuit 14 does not output the signal which causes the switch 13 to turn on. Thus, the switch 13 is switched to a side which does not apply the driver voltage to the piezoelectric element 12 (FIG. 3B).

According to the above-mentioned temperature control mechanism, in a state (a normal temperature state) where the temperature of the piezoelectric element 12 is higher than the switch temperature, which is a predetermined temperature, the piezoelectric element 12 contacts the LD element 10 (FIG. 3A), and a heat of the LD element 10 flows to the case 11 through the piezoelectric element 12. Thereby, the heat of the LD element 10 is released to the circumference through the piezoelectric element 12 and the case 11, and the LD element 10 is cooled. On the other hand, in a state (a low-temperature state) where the temperature of the piezoelectric element 12 is lower than the switch temperature, the piezoelectric element 12 separates from the LD element 10 (FIG. 3B), and the heat of the LD element 10 does not flow to the case 11 through the piezoelectric element 12. Therefore, the heat of the LD element 10 is accumulated inside the LD element 10, and the temperature of the LD element 10 rises.

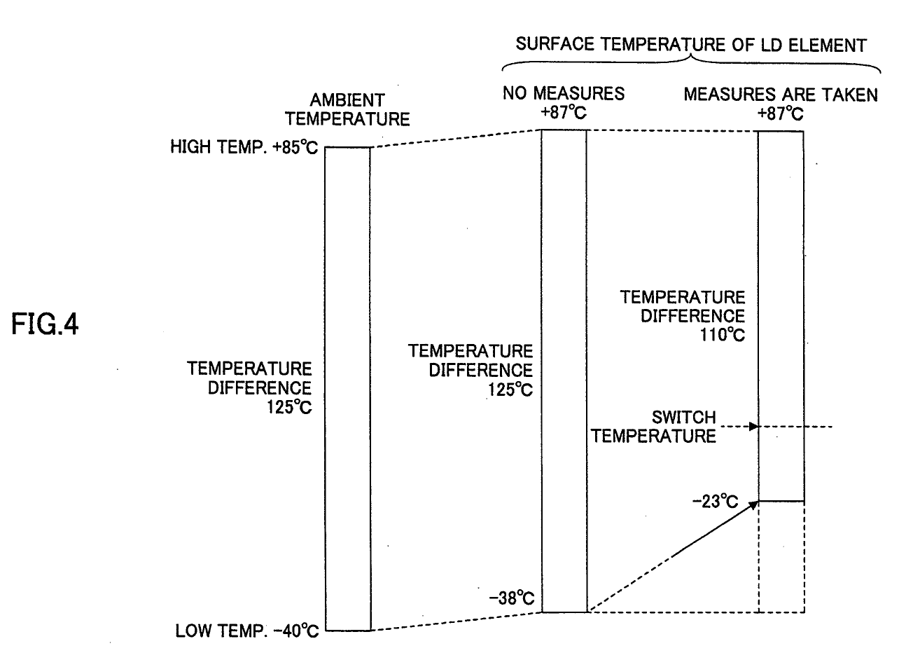

FIG. 4 is an illustration for explaining the effect of the above-mentioned temperature control mechanism. It is assumed that an ambient temperature range of the optical device is −40° C. to +85° C.

In a case where the LD element 10 always radiates heat to the case 11 as is in a conventional one, if the LD element 10 is operated at a temperature of +85° C., which is the highest temperature of the ambient temperature, the surface temperature of the LD element 10 becomes higher than the ambient temperature due to self-heating, and the surface temperature goes up to, for example, +87° C. On the other hand, if the LD element 10 is operated at a temperature of −40° C., which is the lowest temperature of the ambient temperature, the surface temperature of the LD element 10 becomes higher than the ambient temperature due to self-heating, and the surface temperature goes up to, for example, −38° C. In such a case, even if the ambient temperature is the lowest temperature, a heat radiation occurs from the LD element 10 to the case 11. That is, even if the ambient temperature is at the lowest temperature, the LD element 10 is put in a cooled state.

On the other hand, in a case where the temperature control mechanism illustrated in FIG. 3 is provided, if the LD element 10 is operated at a temperature of +85° C., which is the highest temperature of the ambient temperature, the surface temperature of the LD element 10 becomes higher than the ambient temperature due to self-heating, and the surface temperature goes up to, for example, +87° C. This is the same as the conventional case where a heat radiation occurs from the LD element 10 to the case 11. That is, on the high-temperature side, cooling similar to the conventional heat radiation from the case 11 is performed because the piezoelectric element 12 contacts the LD element 10 and the heat of the LD element 10 flows to the case through the piezoelectric element 12. On the other hand, if the LD element 10 is operated at a temperature of −40° C., which is the lowest temperature of the ambient temperature, the surface temperature of the LD element 10 becomes higher than the ambient temperature due to self-heating, and the surface temperature goes up to, for example, −23° C. This is because the piezoelectric element 12 is separated from the LD element 10 when the ambient temperature is lower than the switch temperature, and the LD element 10 is not cooled and rather heated from inside due to self-heating.

As mentioned above, the temperature control can be achieved easily, in which cooling is not performed when the ambient temperature is low and cooling is performed only when the ambient temperature is high, by providing the bimorph-type piezoelectric element 12 between the LD element 10 and the case 11. When the bimorph-type piezoelectric element 12 is in contact with the LD element 10, the heat resistance between the LD element 10 and the case 11 is small, thereby cooling the LD element 10. On the other hand, when the bimorph-type piezoelectric element 12 is separated from the LD element 10, the thermal resistance between the LD element 10 and the case 11 is large, and the LD element 10 is hardly cooled. When the temperature is low, the temperature rise by self-heating of the LD element 10 is larger as a current consumption drive current of the LD element 10 is larger, and, thus, an LD element having a larger current consumption provides a larger effect.

The switch temperature, which is a predetermined temperature for switching the operation of the piezoelectric element 12, may be set to a temperature higher than the lowest temperature by a certain degree. For example, in the example illustrated in FIG. 4, because the temperature is −23° C., when the LD element 10 is not cooled at the ambient temperature of −40° C., the switch temperature can be a temperature higher than −23°.

Moreover, it is not necessary for the sensor 15 to measure the temperature of the LD element 10 with high accuracy, and there is no need to directly attach the sensor 15 to the LD element 10. The sensor 15 may be arranged, for example, in a part contacting the LD element 10 or near the part. Alternatively, the temperature inside the case 11 may be measured to use as the surface temperature of the LD element 10, or the surface temperature of the LD element 10 may be acquired by calculating the surface temperature in accordance with a temperature inside the case 11.

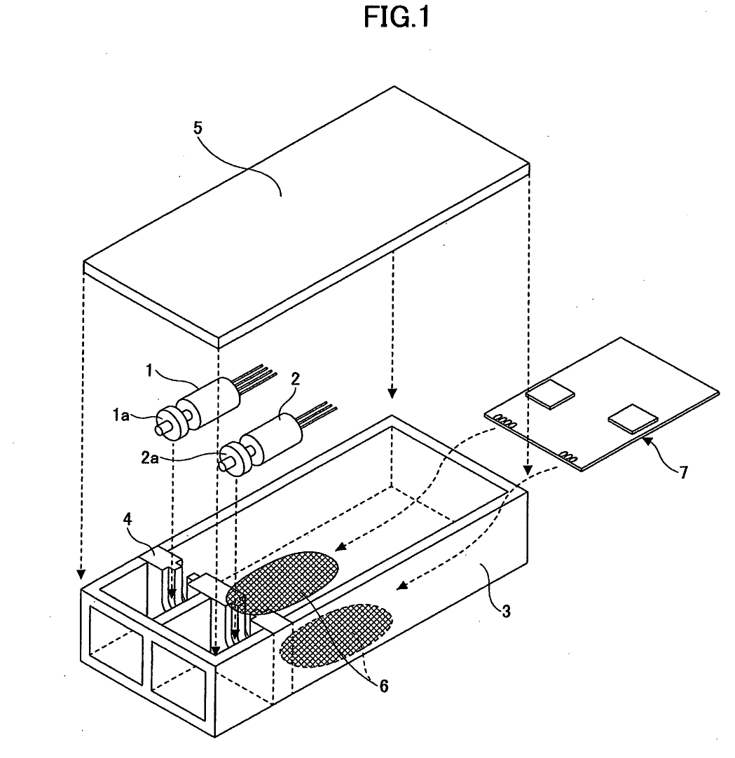

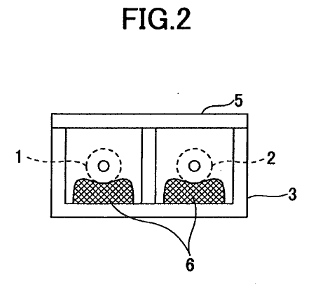

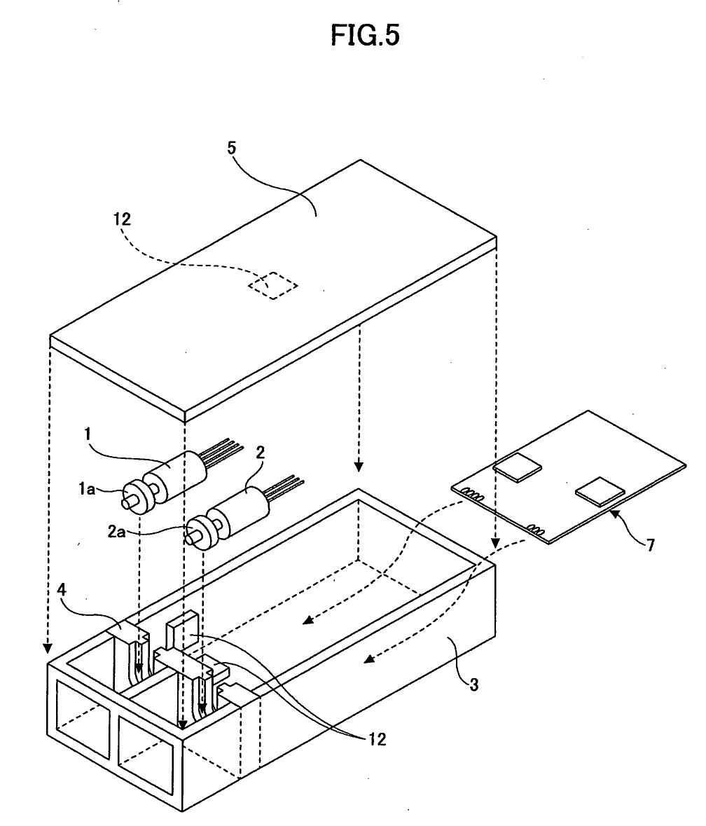

A description will now be given of an optical device according to a first embodiment. FIG. 5 is an exploded perspective view of an optical device according to a first embodiment. In FIG. 5, parts that are the same as the parts illustrated in FIG. 1 are given the same reference numerals, and descriptions thereof will be omitted.

The optical device shown in FIG. 5 is an optical transmitter and receiver module, which incorporates a TOSA and a ROSA into one case as the same as the optical device illustrated n FIG. 1. However, in the optical device illustrated in FIG. 5, the temperature of the LD element 1 is controlled by a temperature control mechanism illustrated n FIG. 3. That is, in the optical device illustrated in FIG. 5, the LD element 1 is not cooled by being brought into contact with a heat transfer sheet but cooled through a bimorph-type piezoelectric element 12 provided between the LD element 1 and the case 3. The bimorph-type piezoelectric element 12 is attached to a wall surface of the case 3 and an inner surface of the lid 5. The case 3 and the lid 5 together form a housing of the optical device.

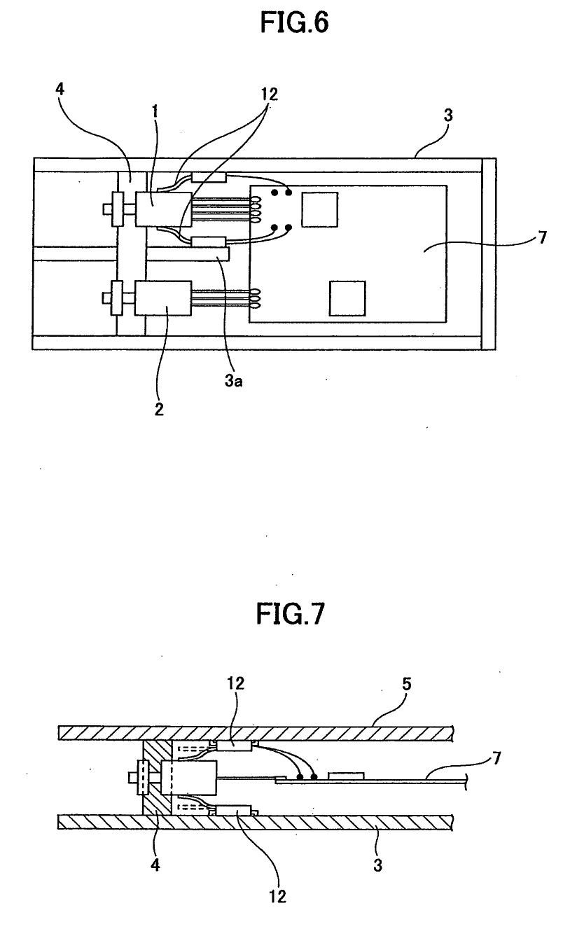

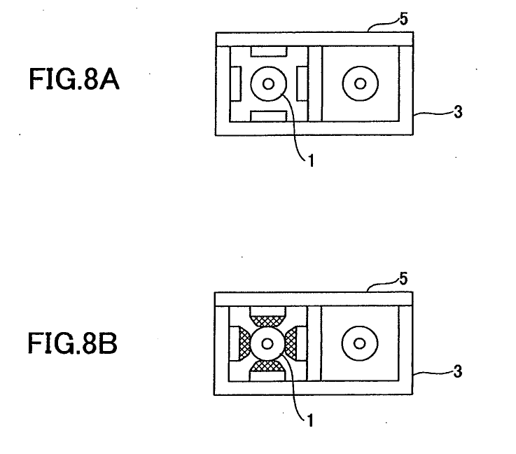

FIG. 6 is a plan view of the optical device illustrated in FIG. 5 in a state where the lid 5 is removed. FIG. 7 is a side view illustrating the circumference of the LD element 1 incorporated in the case 3. FIG. 8 is an illustration indicating a positional relationship between the LD element and the bimorph-type piezoelectric element when viewed from a front of the optical device illustrated in FIG. 8.

Although not illustrated in FIG. 5, as illustrated in FIG. 6, a wall part 3a is provided between the LD element 1 and the LD element 2. The wall part 3a is a portion, which upstands perpendicularly from the bottom surface of the case 3.

Because the cooling effect of the LD element 1 is larger as a number of the bimorph-type piezoelectric elements 12 increases, four bimorph-type piezoelectric elements 12 are arranged in four directions around the LD element 1 in the present embodiment, as illustrated in FIG. 8, so that each of the bimorph-type piezoelectric elements 12 can be brought into contact with the LD element 1.

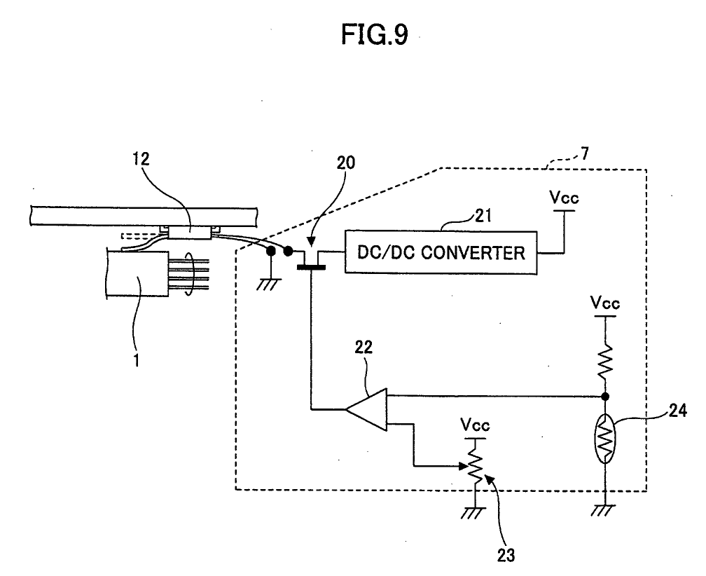

FIG. 9 is an enlarged view of the bimorph-type piezoelectric element 12 and the circumference thereof illustrated in FIG. 6. A control circuit for applying a driver voltage to the bimorph-type piezoelectric element 12 is also illustrated in FIG. 9. Electrodes of the bimorph-type piezoelectric element 12 is connected to a circuit board 7, and a voltage is applied from the control circuit of the circuit board 7. One of the electrodes of the bimorph-type piezoelectric element 12 is connected to a grounding electrode of the circuit board 7, and the other of the electrodes is connected to a drain of a field-effect transistor (FET) 20. The FET 20 corresponds to the switch 13 illustrated in FIG. 3. One of input terminals of a comparator 22 is connected to a thermister 24, and is supplied with a voltage (first voltage) corresponding to a temperature detected by the thermister 24. The thermister 24 corresponds to the sensor 15 illustrated in FIG. 3. A variable resistor 23, which functions as a switch voltage setting part, is connected to the other of the input terminals of the comparator 22, and is supplied with a switch voltage (second voltage) corresponding to a switch temperature. The switch voltage can be set to a desired voltage by adjusting the variable resistor 23.

The comparator 22 compares the voltage (first voltage) from the thermister 24 with the switch voltage (second voltage) from the variable resistor 23, and outputs an ON signal to the FET 20 if the voltage from the thermister 24 is equal to or larger than the switch voltage. When the ON signal is supplied to the gate of the FET 20, the FET 20 opens so that a voltage from the DC/DC converter 21 is supplied to the bimorph-type piezoelectric element 12. The bimorph-type piezoelectric element 12 curves due to the voltage from the DC/DC converter 21, and is brought into contact with the LD element 1. Thereby, a heat is transmitted from the LD element 1 to the case 3 or the lid 5, which is a part of the housing, through the bimorph-type piezoelectric element 12, which results in cooling the LD element 1.

In other words, if the voltage from the thermister 24 is smaller than the switch voltage, the ON signal is not output to the FET 20 and the FET 20 is shut so that the voltage from the DC/DC converter 21 is not supplied to the bimorph-type piezoelectric element 12. Therefore, because the bimorph-type piezoelectric element 12 is not driven and does not curve, the bimorph-type piezoelectric element 12 is separated from the LD element 1. In this state, heat is hardly transmitted from the LD element 1 to the housing (the case 3 or the lid 5), and the LD element 1 is not cooled and the temperature of the LD element 1 rises due to internal heat generation. Therefore, when an ambient temperature is low and lower than the switch temperature, the LD element 1 generates heat by a drive current flowing in the LD element 1 itself, and the temperature of the LD element becomes a temperature higher than the ambient temperature. Therefore, even if the LD element 1 cannot operate normally when the ambient temperature is low, the temperature of the LD element 1 rises due to self-heating, and is set to a state where the LD element 1 can operate normally.

As mentioned above, even if the LD element 1 is one, which does not operate normally, for example, at −40° C., the temperature of the LD element 1 rises up to −23° C. because the temperature of the LD element 1 rises due to self-heating, which permits the LD element 1 operating normally. That is, an LD element, which cannot operate normally, can be used in an optical device. Thus, there is no need to select a usable LD element or a temperature range for the selection can be enlarged, which improves a yield rate of the LD element. Therefore, a manufacturing cost of the LD element can be reduced and, as a result, a manufacturing cost of an optical device can be reduced.

It should be noted hat although the above-mentioned optical device is the optical transmitter and receiver module in which the LD element 1 and the PD element 2 are incorporated in the case 3, the optical device may be one (TOSA) in which only the LD element 1 is incorporated.

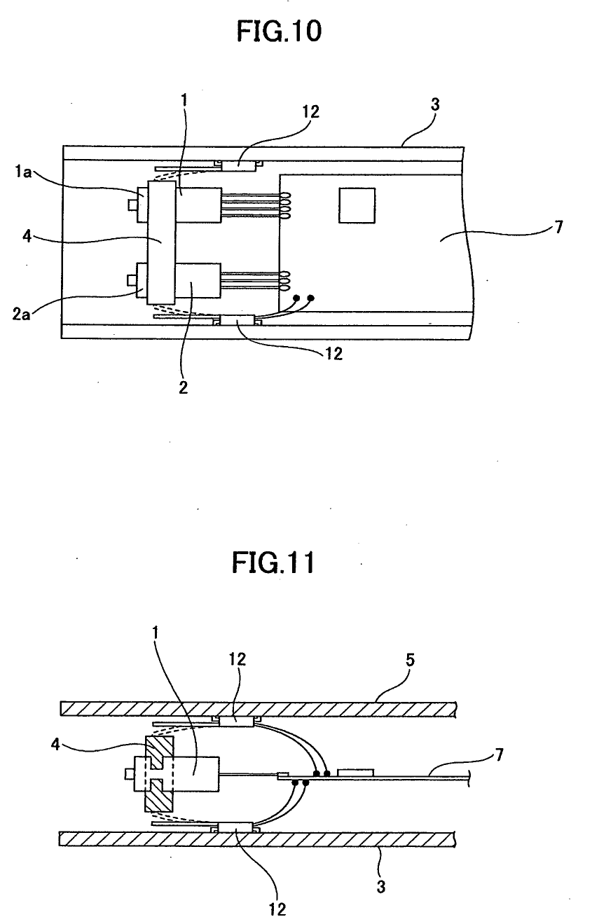

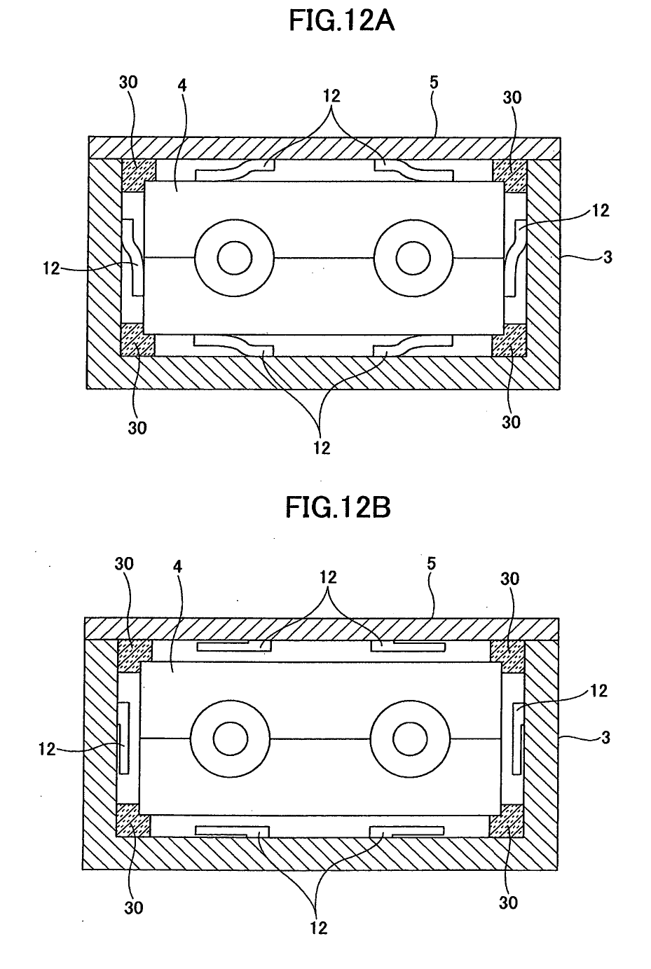

Next, a description will be given of a second embodiment. FIG. 10 is a plan view illustrating an LD element and bimorph-type piezoelectric elements and a circumference thereof in an optical device according to the second embodiment. FIG. 11 is a side view illustrating the LD element, the bimorph-type piezoelectric elements and the circumference thereof illustrated in FIG. 10. FIGS. 12A and 12B are illustrations for explaining an operation of the bimorph-type piezoelectric elements illustrated in FIG. 10.

In the present embodiment, the LD element 1 is cooled by not directly contact the bimorph-type piezoelectric element 12 with the LD element 1 but bringing the bimorph-type piezoelectric elements 12 into contact with a side surface of a holder 4, which is a support member for supporting the LD element 1. The holder 4 is a member, which sandwiches and supports the LD element 1 and the PD element 2 so that heat of the LD element 1 is transmitted easily to the holder 4. In the present embodiment, as shown in FIG. 12, the holder 4 is attached to the case 3 and the lid 5 via an insulating material 30. Accordingly, the holder 4 and each of the case 3 and the lid 5 are thermally separated from each other.

The bimorph-type piezoelectric elements 12 are attached to the inner surfaces of the case 3 and the lid 5, and arranged to be brought into contact with side surfaces of the holder 4 when being deformed. An operation of the bimorph-type piezoelectric elements 12 is controlled by the control circuit illustrated in FIG. 9. In the present embodiment, when an ambient temperature is high, as illustrated in FIG. 12A, the bimorph-type piezoelectric elements 12 contacts the holder 4, and heat is transmitted from the holder 4 to the case 3 and the lid 5 through the bimorph-type piezoelectric elements 12. Therefore, the heat generated in the LD element 1 and the PD element 2, which are supported by the holder 4, is transmitted to the case 3 and the lid 5 through the holder 4 and the bimorph-type piezoelectric elements 12, and radiated to the circumference, thereby cooling the LD element 1 and the PD element 2.

On the other hand, when an ambient temperature is low, as shown in FIG. 12B, the bimorph-type piezoelectric elements 12 separate from the holder 4, and the holder 4 is thermally separated from each of the case 3 and the lid 5. Accordingly, heat generated in the LD element 1 and the PD element 2, which are supported by the holder 4, is accumulated in the holder 4, and the temperature of the holder 4 rises and the temperature of the LD element 1 also rises.

As mentioned above, the same effect as the above-mentioned first embodiment can be acquired also with the present embodiment. In addition, in the present embodiment, when an ambient temperature is high, the PD element 2 supported by the holder 4 is also cooled in the same manner as the LD element 1. If an ambient temperature is high, the holder 4 is also heated by heat from the PD element 2.

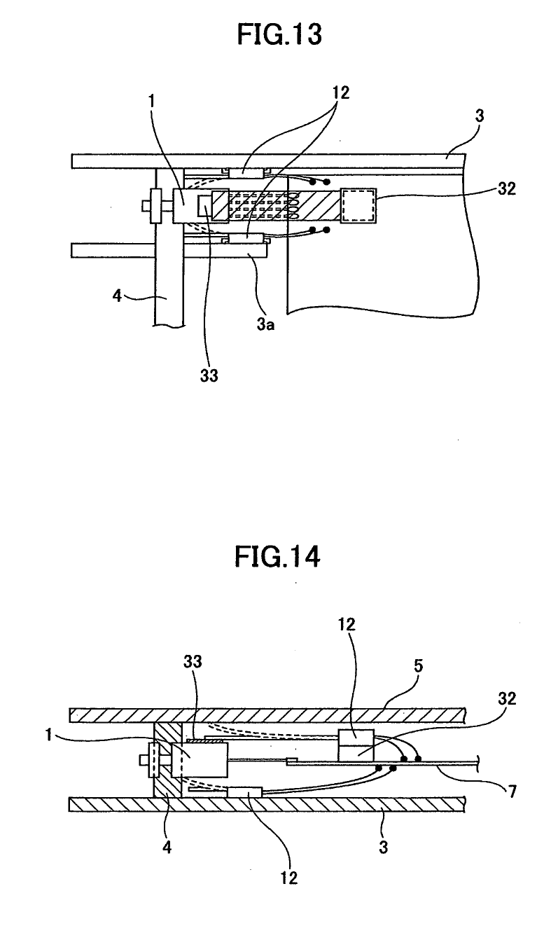

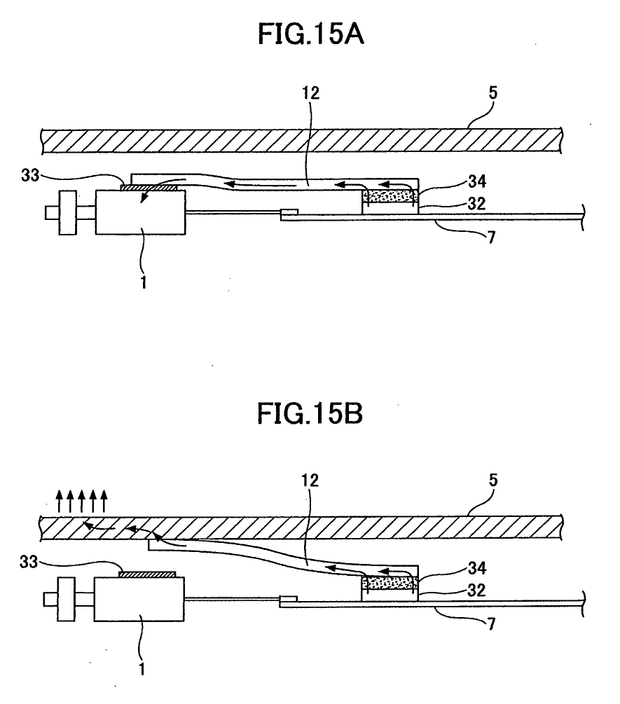

Next, a description will be given of a third embodiment. FIG. 13 is a plan view illustrating an LD element and a bimorph-type piezoelectric element and a circumference thereof in an optical device according to the third embodiment. FIG. 14 is a side view illustrating the LD element, the bimorph-type piezoelectric element and the circumference thereof illustrated in FIG. 13. FIGS. 15A and 15B are illustrations for explaining an operation of the bimorph-type piezoelectric element illustrated in FIG. 13.

Although the optical device according to the present embodiment has the same structure as the optical device according to the above-mentioned first embodiment, the optical device according to the present embodiment differs from the optical device according to the first embodiment in that one of the bimorph-type piezoelectric elements 12 (only the piezoelectric element 12 attached to the lid 5) is attached to an LSI 32 mounted on the circuit board 7. The LSI 32 is an LSI for driving the LD element 1, and is a heating element, which generates heat when driving the LD element 1.

The bimorph-type piezoelectric element 12 attached to the LSI 32 by a thermally conductive adhesive 34 is driven and deformed, as illustrated in FIG. 15B, when an ambient temperature is high, and a free end part of the bimorph-type piezoelectric element 12 contacts the lid 5. Accordingly, when an ambient temperature is high, heat of the LSI 32 is released to the lid 5, and, thereby, the LSI 32 is cooled. On the other hand, when an ambient temperature is low, that is, when an ambient temperature is lower than the switch temperature, the bimorph-type piezoelectric element 12 does not deform, as illustrated in FIG. 15A, and is in a state where the bimorph-type piezoelectric element 12 is pressed against the LD element 1 via a heat transfer sheet 33. Accordingly, when an ambient temperature is lower than the switch temperature, heat generated in the LSI 32 is transmitted to the LD element 1 through the bimorph-type piezoelectric element 12 and the heat transfer sheet 33, and, thereby, the LD element 1 is heated.

It should be noted that if a good contact is achieved between the bimorph-type piezoelectric element 12 and the LD element 1, it is not necessary to always provide the heat transfer sheet 33.

As mentioned above, according to the present embodiment, when an ambient temperature is low, heat can be transmitted to the LD element 1 from other heat-generating elements through the bimorph-type piezoelectric element 12, and the LD element 1 can be heated also by heat from the outside in addition to self-heating of the LD element 1. Thus, when an ambient temperature is low, the temperature of the LD element 1 can be raised further.

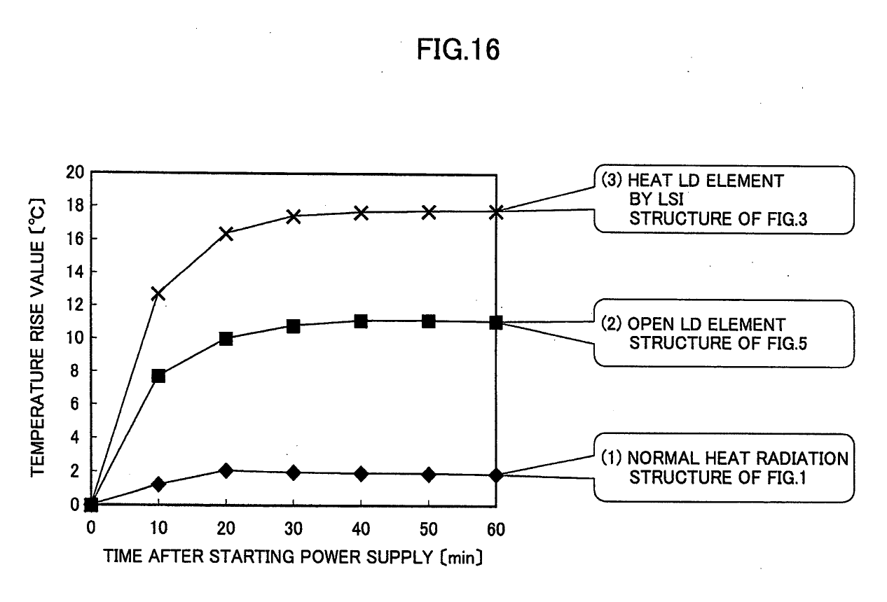

In order to check the effect of the present embodiment, the structure illustrated in FIG. 1, the structure illustrated in FIG. 5 and the structure illustrated in FIG. 13 were produced, and a temperature rise in each of the structures was measured. FIG. 16 is a graph indicating the temperature rises after turning on a power. In the structure illustrated in FIG. 1, that is, in the structure where heat is always radiated from the LD element, the temperature rise value of the LD element at a time 60 minutes after a power is turned on was 2° C. On the other hand, in the structure illustrated in FIG. 5, that is, in the structure where the bimorph-type piezoelectric element is separated from the LD element and cooling is not carried out at a temperature equal to or lower than the switch temperature, the temperature rise value of the LD element at a time 60 minutes after a power was turned on was 9° C. Moreover, in the structure illustrated in FIG. 13, that is, in the structure where the LD element is heated by a heat from the LSI at a temperature equal to or lower than the switch temperature, the temperature rise value of the LD element at a time 60 minutes after a power was turned on was 16° C. Because an LD element having a higher normal operation temperature can be used as the temperature rise value is larger, it was confirmed that the optical device according the third embodiment is most effective.

All examples and conditional language recited-herein are intended for pedagogical purposes to aid the reader in understanding the principles of the invention and the concepts contributed by the inventor to furthering the art, and are to be construed a being without limitation to such specifically recited examples and conditions, nor does the organization of such examples in the specification relates to a showing of the superiority and inferiority of the invention. Although the embodiments of the present invention have been described in detail, it should be understood that the various changes, substitutions, and alterations could be made hereto without departing from the spirit and scope of the invention.

1. An optical device comprising:
optical parts including a laser diode element;
a housing accommodating the optical parts;
a bimorph-type piezoelectric element arranged in a vicinity of the laser diode element and having a free end contacting one of said laser diode element, a support member supporting said laser diode element, and said housing; and
a control circuit controlling an operation of the bimorph-type piezoelectric element.

2. The optical element according to claim 1, wherein a fixed end of said bimorph-type piezoelectric element is fixed to said housing, and said free end is brought into contact with said laser diode element or said support member when said bimorph-type piezoelectric element is in operation.

3. The optical element according to claim 1, wherein said support member supporting said laser diode element is mounted to said housing via an insulating material.

4. The optical element according to claim 1, wherein the fixed end of said bimorph-type piezoelectric element is fixed to a heat-generating part accommodated in said housing, and said free end is brought into contact with said housing when said bimorph-type piezoelectric element is in operation.

5. The optical device according to claim 4, wherein said heat-generating part is an LSI forming a circuit for driving said laser diode element.

6. The optical device according to claim 1, wherein said control circuit causes said bimorph-type piezoelectric element to be in an operated state by applying a drive voltage thereto when a surface temperature of said laser diode element is equal to or greater than a predetermined temperature, and causes said bimorph-type piezoelectric to be in an non-operated state by stopping the application of a drive voltage thereto when the surface temperature of said laser diode element is lower than the predetermined temperature.

7. The optical device according to claim 2, wherein the fixed end is fixed to a heat-generating part accommodated in said housing, and said free end further includes a second piezoelectric element being brought into contact with said housing when said piezoelectric element is in operation, and wherein said piezoelectric element is caused to be in a non-operated state by stopping a drive voltage when the surface temperature of said laser diode element is lower than a predetermined temperature, and causes a free end of said second piezoelectric element to be brought into contact with said laser diode element or said support member supporting said laser diode element.

8. The optical device according to claim 6, wherein said control circuit includes:
a temperature sensor detecting a temperature of said laser diode element or a temperature of a periphery of said laser diode element;
a comparison circuit comparing a first voltage from the temperature sensor with a second voltage representing said predetermined temperature so as to output an ON signal when the second voltage is equal to or greater than the first voltage; and
a switch applying a drive voltage to said bimorph-type piezoelectric element when the ON signal is supplied.

9. The optical device according to claim 8, wherein said switch includes a field effect transistor, and said ON signal is supplied to a gate of the field effect transistor.

10. The optical device according to claim 8, wherein said temperature sensor includes a thermister, and the thermister is mounted to a circuit board where said control circuit is formed.

11. The optical device according to claim 8, wherein said control circuit includes a variable resistor generating said second voltage.

12. The optical element according to claim 2, wherein said support member supporting said laser diode element is mounted to said housing via an insulating material.

13. The optical device according to claim 2, wherein said control circuit causes said bimorph-type piezoelectric element to be in an operated state by applying a drive voltage thereto when a surface temperature of said laser diode element is equal to or greater than a predetermined temperature, and causes said bimorph-type piezoelectric to be in an non-operated state by stopping the application of a drive voltage thereto when the surface temperature of said laser diode element is lower than the predetermined temperature.

14. The optical device according to claim 3, wherein said control circuit causes said bimorph-type piezoelectric element to be in an operated state by applying a drive voltage thereto when a surface temperature of said laser diode element is equal to or greater than a predetermined temperature, and causes said bimorph-type piezoelectric to be in an non-operated state by stopping the application of a drive voltage thereto when the surface temperature of said laser diode element is lower than the predetermined temperature.

15. The optical device according to claim 4, wherein said control circuit causes said bimorph-type piezoelectric element to be in an operated state by applying a drive voltage thereto when a surface temperature of said laser diode element is equal to or greater than a predetermined temperature, and causes said bimorph-type piezoelectric to be in an non-operated state by stopping the application of a drive voltage thereto when the surface temperature of said laser diode element is lower than the predetermined temperature.

16. The optical device according to claim 5, wherein said control circuit causes said bimorph-type piezoelectric element to be in an operated state by applying a drive voltage thereto when a surface temperature of said laser diode element is equal to or greater than a predetermined temperature, and causes said bimorph-type piezoelectric to be in an non-operated state by stopping the application of a drive voltage thereto when the surface temperature of said laser diode element is lower than the predetermined temperature.

17. The optical device according to claim 3, wherein the fixed end is fixed to a heat-generating part accommodated in said housing, and said free end further includes a second piezoelectric element being brought into contact with said housing when said piezoelectric element is in operation, and wherein said piezoelectric element is caused to be in a non-operated state by stopping a drive voltage when the surface temperature of said laser diode element is lower than a predetermined temperature, and causes a free end of said second piezoelectric element to be brought into contact with said laser diode element or said support member supporting said laser diode element.

18. The optical device according to claim 4, wherein the fixed end is fixed to a heat-generating part accommodated in said housing, and said free end further includes a second piezoelectric element being brought into contact with said housing when said piezoelectric element is in operation, and wherein said piezoelectric element is caused to be in a non-operated state by stopping a drive voltage when the surface temperature of said laser diode element is lower than a predetermined temperature, and causes a free end of said second piezoelectric element to be brought into contact with said laser diode element or said support member supporting said laser diode element.

19. The optical device according to claim 5, wherein the fixed end is fixed to a heat-generating part accommodated in said housing, and said free end further includes a second piezoelectric element being brought into contact with said housing when said piezoelectric element is in operation, and wherein said piezoelectric element is caused to be in a non-operated state by stopping a drive voltage when the surface temperature of said laser diode element is lower than a predetermined temperature, and causes a free end of said second piezoelectric element to be brought into contact with said laser diode element or said support member supporting said laser diode element.
